(19) United States
(12) Patent Application Publication
(10) Pub. No.: US 2020/0148061 A1
(43) Pub. Date: May 14, 2020

(54) ROTARY CONTROL DEVICE

(71) Applicant: ZF Friedrichshafen AG, Friedrichshafen (DE)

(72) Inventors: Rainer HAEVESCHER, Stemwede (DE); Artur Neumann, Kalletal (DE)

(73) Assignee: ZF Friedrichshafen AG, Friedrichshafen (DE)

(21) Appl. No.: 16/624,231

(22) PCT Filed: May 23, 2018
(86) PCT No.: PCT/EP2018/063548

§ 371 Date: Dec. 18, 2019

(30) Foreign Application Priority Data
Jun. 21, 2017 (DE) 10 2017 210 439.2

(51) Int. Cl. B60K 37/06; H01F 1/44; B60R 16/00; G05G 1/08; G05G 5/03; G06F 3/0362; G06F 3/01

(52) U.S. Cl. CPC B60K 37/06; H01F 1/447; B60R 16/005; G05G 1/08; B60K 2370/158; G06F 3/0362; G06F 3/016; B60K 2370/126; G05G 5/03

(57) ABSTRACT

The invention relates to a rotary control device (1) for a vehicle comprising a user interface surface (3), in particular a knob, that is embodied to rotate with respect to a housing (5) of the device (1) around a rotational axis (7) of the device (1), further comprising a sensor unit (9) for monitoring the orientation and/or rotational movement of the user interface surface (3) with respect to the housing (5), a processing unit (11), and a communications interface (13) for transmitting control signals (Ts) according to an output (Op) from the processing unit (11), said output (Op) being generated by the processing unit (11) on the basis of sensor data (Ds) from the sensor unit (9).

The invention relates to a rotary control device comprising a user interface surface that is embodied to rotate with respect to a housing of the device around a rotational axis of the device, further comprising a sensor unit for monitoring the orientation and/or rotational movement of the user interface surface with respect to the housing, a processing unit, and a communications interface for transmitting control signals according to an output from the processing unit, said output being generated by the processing unit on the basis of sensor data from the sensor unit, wherein the rotary control device further comprises a magnetorheological actuator, wherein the magnetorheological actuator comprises a rotational element that is mechanically connected to the user interface surface and serves to interact with a magnetorheological fluid of the magnetorheological actuator, and wherein the magnetorheological actuator comprises an assembly for generating and/or manipulating properties of a magnetic field acting on the magnetorheological fluid such that the magnetorheological actuator serves to modulate torque transmission between the user interface surface and the housing.

Haptic interfaces for control are known for example from the European patent publication EP2065614A1, wherein an assembly for manipulating properties of a magnetic field is disclosed for the purpose of modulating the torque transfer between a rotational element and a housing of the haptic interface.

The object of the invention is to introduce an improved rotary control device.

The object of the invention is achieved by a rotary control device defined by the subject matter of the independent claim. The dependent claims and the description define advantageous embodiments of the system.

The object is therefore achieved by a rotary control device comprising a user interface surface that is embodied to rotate with respect to a housing of the device around a rotational axis of the device, further comprising a sensor unit for monitoring the orientation and/or rotational movement of the user interface surface with respect to the housing, a processing unit, and a communications interface for transmitting control signals according to an output from the processing unit, said output being generated by the processing unit on the basis of sensor data from the sensor unit, wherein the rotary control device further comprises a magnetorheological actuator, wherein the magnetorheological actuator comprises a rotational element that is mechanically connected to the user interface surface and serves to interact with a magnetorheological fluid of the magnetorheological actuator, and wherein the magnetorheological actuator comprises an assembly for generating and/or manipulating properties of a magnetic field acting on the magnetorheological fluid such that the magnetorheological actuator serves to modulate torque transmission between the user interface surface and the housing, wherein the actuator is embodied to generate and/or manipulate the properties of the magnetic field according to haptic-feedback signals received by the device via the communications interface.

A position of the user interface surface in the sense of the invention refers to the placement of the user interface surface within a plane spatially displaced from the housing of the device by a specified distance. An orientation of the user interface surface in the sense of the invention refers to a rotational displacement of the user interface surface around the rotational axis of the device by a specific degree of rotation with respect to an initial setting of the user interface surface with reference to the housing.

The magneto-rheological fluid defines the behavior of the rotary control device. To this end, a voltage supplied to the assembly is varied to induce a surrounding magnetic field that changes the viscosity of the fluid. Depending on the magnetic field, in particular depending on properties of the magnetic field such as intensity and/or direction, the MRF can vary between liquid and solid state, which can be controlled very accurately. In a fluid state, MRF transfers little to no torque between the rotational element and the housing. However, as the viscosity increases and the fluid approaches a solid state, the sheer forces within the fluid and between the fluid and the rotational element as well as between the fluid and the housing, or a component attached fixedly to the housing, increases. This leads to an increasing torque transfer between the user interface surface and the housing.

The device can be used to select an operation mode of the vehicle, which is for example a forwards drive operation mode wherein torque is transferred from a drive unit of the vehicle in order to propel the vehicle in a forwards direction, a reverse drive operation mode wherein torque is transferred from a drive unit of the vehicle in order to propel the vehicle in a reverse direction, a neutral operation mode wherein no torque is transferred from a drive unit of the vehicle, a park operation mode where a torque transmission unit attached to the drive unit of the vehicle is mechanically blocked, or another operation mode.

When a position and/or orientation of the user interface surface remains constant in the absence of a force applied the device from an external source, then this position and/or orientation of the user interface surface can be referred to as a stable position. On the other hand, when the user interface surface does not remain in a certain position or orientation, because for example a mechanism of the device applies a force internally, then this position and/or orientation can be referred to as being non-stable.

A safety relevant function of the vehicle in the sense of the invention can be for example the selection of an operation mode of the vehicle, steering, accelerating or braking the vehicle. A non-safety function of the vehicle can be for example navigation or control of a multimedia interface.

A communications pathway in the sense of the invention can be for example a hardline for transferring data such as a databus and/or a wireless data transmission channel. In many modern street vehicles, a CAN-databus is a preferred type of communications pathway.

The user interface surface, or knob, in the sense of the invention can comprise the outer surface of a ring shaped and/or half shell shaped structure, which is accessible to an operator, i.e. user, of the vehicle. The user interface surface can further comprise a construction underlying the outer surface of the user interface surface.

In an embodiment of the rotary control device the processing unit is embodied to output governing signals for governing the assembly for generating and/or manipulating the properties of the magnetic field on the basis of sensor data from the sensor unit

In an embodiment of the rotary control device the sensor unit of the device further comprises a sensor for monitoring the torque applied to the user interface surface.

In an embodiment of the rotary control device, the processing unit is embodied to output governing signals for governing the assembly such that the assembly manipulates the magnetic field acting on the fluid to fluctuate, thereby simulating a vibrational haptic feedback to a user applying torque to the user interface surface at the moment of fluctuation.

In an embodiment of the rotary control device the mechanical connection between the user interface surface and the rotational element comprises an elastic element that serves to reduce the torsional rigidity of the mechanical connection with respect to the rotational axis.

In an embodiment of the rotary control device the elastic element is embodied such that it can store and release energy applied to the user interface surface by a user of the device.

In an embodiment of the rotary control device the sensor unit of the device further monitors the acceleration of the rotational movement of the user interface surface with respect to the housing.

In an embodiment of the rotary control device the processor unit is embodied to output governing signals that control the assembly to manipulate the magnetic field such that the torque transmission is, in an alternating manner, removed and increased to a predetermined value at intervals, such that when a torque is applied to the user interface surface from an external source, the user interface surface moves incrementally at intervals.

In an embodiment of the rotary control device the rotary control device further comprises a servo actuator that is embodied to apply torque to the user interface surface in accordance with governing signals output by the processing unit of the device.

In an embodiment of the rotary control device the rotational element comprises a chamber containing the magnetorheological fluid, and in that a static element is provided, which is fixedly arranged with respect to the housing and arranged at least partially within the chamber, such that the torque transmission between inner surface of the chamber of the rotational element and the static element is dependent on the properties of a magnetic field.

In an embodiment of the rotary control device the rotational element is embodied to rotate within a chamber of the actuator containing the magnetorheological fluid, said chamber being fixedly arranged with respect to the housing, such that the torque transmission between the rotational element and an inner surface of the chamber is dependent on the properties of a magnetic field.

A System for a vehicle comprising such an embodiment of the rotary control device can further comprise a graphical user interface unit comprising a display and a processing unit, the system further comprising a communications pathway between the rotary control device and the graphical user interface unit.

Such a system can further be embodied such that the graphical user interface unit transmits haptic-feedback signals to the rotary control device via the communications pathway.

Such a system can further be embodied such that the rotary control device transmits control signals to the graphical user interface unit, and wherein the display of the graphical user interface unit displays a visual feedback according to the control signals received from the device

Certain embodiments of the invention will next be explained in detail with reference to the following figures. They show:

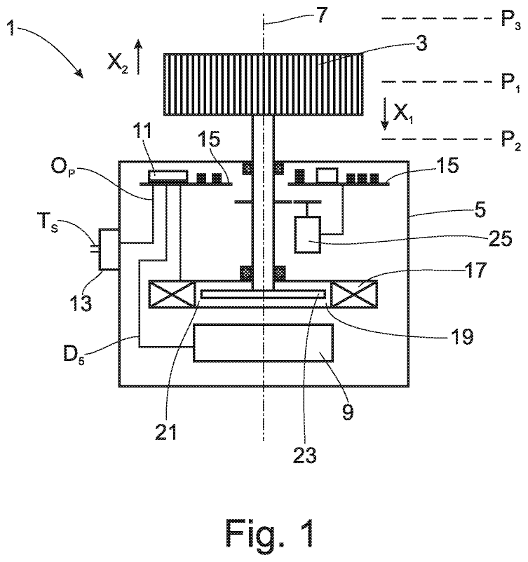

FIG. 1 a schematic diagram of an embodiment of the inventive rotary control device;

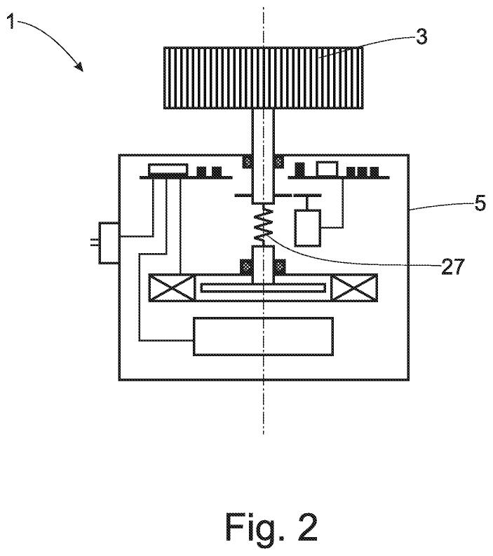

FIG. 2 a schematic diagram of an embodiment of the inventive rotary control device;

FIG. 1 shows a schematic diagram of an embodiment of the inventive rotary control device 1 having a user interface surface 3, which can be moved and rotated by a user or operator of a vehicle. The user interface surface can be rotated around a rotational axis 7 of the device 1 to various orientations Al -. The user interface surface 3 can furthermore be moved by a user or operator of the vehicle between a first, second and third position P1, P2, P3.

The device 1 comprises a housing 5, which at least partially encloses a processing unit 11 mounted on a substrate 15, which is a printed circuit board. The processing unit 11 is connected to a communications interface 13. Via the communications interface 13 signals such as control signals Ts can be transmitted and received. The processing unit 11 is further connected to a sensor unit 9 which serves to monitor the rotational movement and/or orientation of the user interface surface with respect to the housing 5. The sensor unit 9 transmits sensor data Ds to the processing unit 11 and on the basis of this sensor data Ds, the processing unit 11 can generate control signals to transmit via the communications interface 13.

The device further comprises an assembly 17 for generating and manipulating a magnetic field in a chamber 19 of the housing 5. The chamber contains a magnetorheological fluid 21 also known as MRF. Positioned partially within the chamber is a rotational element 23. The rotational element 23 is mechanically connected to the user interface surface 3 and rotates with the rotation of the interface 3.

Corresponding to changes in properties of the magnetic field caused by the assembly 17, such as field strength and direction, the magnetorheological fluid 12 varies in viscosity so to speak. Therefore, in a corresponding way, the fluid transfers more or less torque between the user interface surface 3 and the housing 5 of the device 1. This is due to the changing sheer forces within the fluid and between the fluid and the chamber wall. Since the housing 5 of the device is generally fixedly mounted within the vehicle, the assembly can be considered to modulate a sort of braking force acting on the user interface surface 3. Such systems comprising MRF 21 in a chamber 19, rotational elements 23, and assemblies 17 for manipulating the magnetic field within the chamber 19 are often referred to as MRF-Actuators. The processing unit 11 is embodied to output governing signals for controlling the assembly 17. The assembly 17 can, for example, be driven by a circuit on the substrate 15 feeding the assembly 17 with a pulsed width modulated (PWM) current or voltage in accordance with the governing signals from the processing unit 11.

The device further comprises a servo actuator 25 which engages with the rotational element 23 and can therefore apply torque to the user interface surface 3.

FIG. 2 shows a schematic diagram of an embodiment of the inventive rotary control device which corresponds to the first embodiment with the exception that an elastic element 27 is shown. The elastic element 27 serves to reduce the torsional rigidity between the user interface surface 3 and the MRF actuator, which, when the torque transmission is set at a high value, corresponds to the torsional rigidity between the user interface surface 3 and the housing 7.

When the assembly causes the magnetic field to fluctuate such that the value of the torque transmission fluctuates, then the elastic element will absorb a fraction of the energy input into the system by the external force applying the torque. This energy will then be released such that a torque opposing the externally applied torque is applied to the user interface surface by the elastic element.

### REFERENCE CHARACTERS

1 Rotary control device

3 user interface surface

5 housing

7 rotational axis

9 sensor unit

11 processing unit

13 communications interface

15 substrate/PCB

17 assembly for generating/manipulating magnetic field

19 chamber

21 magnetorheological fluid

23 rotational element

25 servo actuator

27 elastic element

X1 first direction

X2 second direction

P1 first position

P2 second position

P3 third position

1. A rotary control device comprising:
a user interface surface configured to rotate with respect to a housing of the device around a rotational axis of the device;
a sensor unit configured to monitor at least one of an orientation or a rotational movement of the user interface surface with respect to the housing;
a processing unit configured to generate an output on a basis of sensor data from the sensor unit;
a communications interface configured to transmit control signals according to the output from the processing unit; and
a magnetorheological actuator comprising:
a rotational element that is mechanically connected to the user interface surface and serves to interact with a magnetorheological fluid of the magnetorheological actuators; and
an assembly configured to at least one of generate or manipulate properties of a magnetic field acting on the magnetorheological fluid such that the magnetorheological actuator serves to modulate torque transmission between the user interface surface and the housing according to haptic-feedback signals received by the device via the communications interface.

2. The rotary control device according to claim 1, wherein the processing unit is configured to output governing signals for governing the assembly on the basis of the sensor data from the sensor unit.

3. The rotary control device according to claim 1, wherein the sensor unit further comprises a sensor configured to monitor a torque applied to the user interface surface.

4. The rotary control device according to claim 1, wherein the processing unit is configured to output governing signals for governing the assembly to manipulate the magnetic field acting on the fluid to fluctuate to provide a vibrational haptic feedback to a user applying torque to the user interface surface.

5. The rotary control device according to claim 1, wherein a mechanical connection between the user interface surface and the rotational element comprises an elastic element that reduces a torsional rigidity of the mechanical connection with respect to the rotational axis.

6. The rotary control device according to claim 5, wherein the elastic element is configured to store and release energy applied to the user interface surface by a user of the device.

7. The rotary control device according to claim 1, wherein the sensor unit of the is configured to monitor an acceleration of the rotational movement of the user interface surface with respect to the housing.

8. The rotary control device according to claim 1, wherein the processing unit is configured to output governing signals that control the assembly to manipulate the magnetic field such that the torque transmission is, in an alternating manner, removed and increased to a predetermined value at intervals, such that when a torque is applied to the user interface surface from an external source, the user interface surface moves incrementally at intervals.

9. The rotary control device according to claim 1, further comprising:
a servo actuator configured to apply torque to the user interface surface in accordance with governing signals output by the processing unit of the device.

10. The rotary control device according to claim 1, wherein the rotational element comprises a chamber containing the magnetorheological fluid,
wherein the rotary control device further comprises a static element fixedly arranged with respect to the housing and arranged at least partially within the chamber, such that the torque transmission between an inner surface of the chamber of the rotational element and the static element is dependent on the properties of the magnetic field.

11. The rotary control device according to claim 1, wherein the rotational element is configured to rotate within a chamber of the magnetorheological actuator containing the magnetorheological fluid, said chamber being fixedly arranged with respect to the housing, such that the torque transmission between the rotational element and an inner surface of the chamber is dependent on the properties of the magnetic field.

12. A system for a vehicle comprising:
the rotary control device according to claim 1;
a graphical user interface unit comprising a display and a processing unit; and
a communications pathway between the rotary control device and the graphical user interface unit.

13. The system according to claim 12 wherein the graphical user interface unit transmits haptic-feedback signals to the rotary control device via the communications pathway.

14. The system according to claim 12, wherein the rotary control device transmits control signals to the graphical user interface unit, and wherein the display of the graphical user interface unit displays a visual feedback according to the control signals received from the rotary control device.
